(19) United States
(12) Patent Application Publication
(10) Pub. No.: US 2008/0059825 A1
(43) Pub. Date: Mar. 6, 2008

(54) Information processing apparatus, external storage device and control method

(75) Inventor: Yasunori Aramaki, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/896,037

(22) Filed: Aug. 29, 2007

(30) Foreign Application Priority Data
Aug. 31, 2006 (JP) 2006-236859

(51) Int. Cl. G06F 1/32; G06F 12/06

(52) U.S. Cl. 713/324; 711/114; 711/E12.078

(57) ABSTRACT

According to one embodiment, an information processing apparatus, a discrimination unit for discriminating whether a power supply mode is a battery or a AC power supply, a stop unit for stopping supply of power to each of a physical drives, a storing unit for storing a history of stopping the power supply, a canceling unit for temporarily canceling a duplexing state of the disk array if it is discriminated by the discrimination unit that the power supply mode is the battery, and a determination unit for determining a physical drive whose power supply is to be stopped, to average power supply stop counts of the respective physical drives in accordance with the power supply stop history information stored in the storing unit, wherein the supply of power to the physical drive determined by the determination unit is stopped by the stop unit.

### CROSS-REFERENCE TO RELATED APPLICATIONS

This application is based upon and claims the benefit of priority from Japanese Patent Application No. 2006-236859, filed Aug. 31, 2006, the entire contents of which are incorporated herein by reference.

### BACKGROUND

1. Field

One embodiment of the present invention relates to an information processing apparatus, an external storage device and a control method which, upon supplying power to a plurality of physical drives included in a disk array, can stop the supply of the power to a predetermined drive at the time of driving a battery.

2. Description of the Related Art

As for a general technique of disk duplexing as disclosed in, for example, JP-A No. 3-226821 (KOKAI), when reading is conducted in a duplex disk device, rotation of a disk in which reading is not conducted is stopped to reduce the power consumption (cf. JP-A No. 3-226821 (KOKAI)).

According to the above technique, however, the disk rotation is merely stopped, but the power is supplied to the disk and the power is thereby consumed. In addition, the rotation of the disk in which reading is not conducted is stopped, but the stopping is not conducted to average the disk usage rate and the lifetime of the disk having a high usage rate is shortened.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outer appearance of an information processing apparatus according to an embodiment of the present invention;

FIG. 2 is an exemplary block diagram showing main components of the information processing apparatus according to the embodiment of the present invention;

FIG. 3 is an exemplary block diagram showing main functions of an external storage device and the information processing apparatus according to the embodiment of the present invention;

FIG. 4 is an exemplary flowchart of stopping supply of the power to one of two HDD upon changing from the AC power supply to the battery drive according to the embodiment;

FIG. 5 is an exemplary flowchart of restarting the stopped supply of the power to the HDD upon changing from the battery drive to the AC power supply according to the embodiment;

FIG. 6 is an exemplary illustration showing a state in which the power is supplied to two HDD while the computer is operated by the AC power supply according to the embodiment; and

FIG. 7 is an exemplary illustration showing a state in which supply of the power to one of two HDD is stopped while the computer is operated by the battery drive according to the embodiment.

### DETAILED DESCRIPTION

Various embodiments according to the invention will be described hereinafter with reference to the accompanying drawings. In general, according to one embodiment of the invention, according to one embodiment, an information processing apparatus, includes a battery and an AC power supply; a plurality of physical drives included in a disk array; a discrimination unit for discriminating whether a power supply mode is the battery or the AC power supply; a stop unit for stopping supply of power to each of the physical drives; a storing unit for storing a history of stopping the power supply as power supply stop history information, for each of the physical drives; a canceling unit for temporarily canceling a duplexing state of the disk array if it is discriminated by the discrimination unit that the power supply mode is the battery; and a determination unit for determining a physical drive whose power supply is to be stopped next time, to average power supply stop counts of the respective physical drives in accordance with the power supply stop history information stored in the storing unit, wherein the supply of power to the physical drive determined by the determination unit is stopped by the stop unit.

An embodiment of the present invention will be described below with reference to the accompanying drawings.

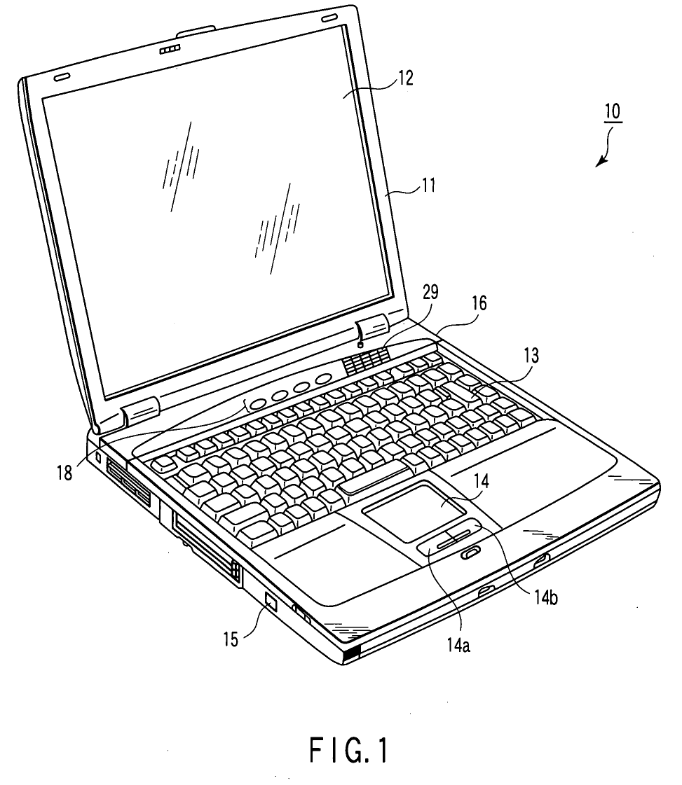

FIG. 1 is a perspective view showing an information processing apparatus according to the embodiment of the present invention. The information processing apparatus is implemented as a battery-operated notebook computer 10. In the present invention, at the battery drive time, a disk duplexing state is temporarily canceled and the power supply to a predetermined disk drive is stopped to reduce the power consumption.

The computer 10 is composed of a main body 16 and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face, a touch pad 14 and two buttons 14a, 14b and various kinds of shortcut buttons 18 for mail, etc., a power button, a volume control button 18, a speaker 29 and the like on a palm rest. An optical drive 15 is provided on a side face of the main body 16.

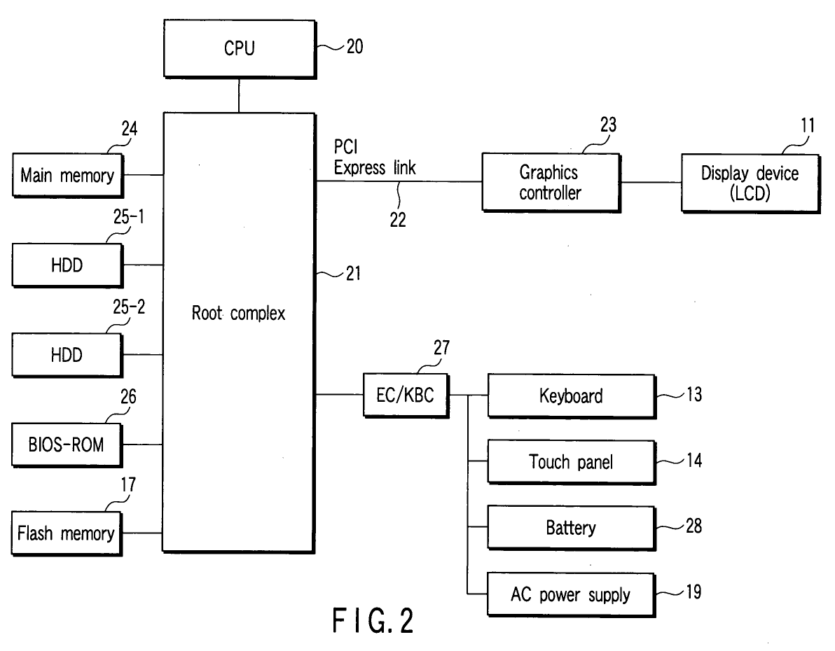

FIG. 2 is a block diagram showing main components in the information processing apparatus according to the embodiment.

The computer 10 comprises a CPU (Central Processing Unit) 20, a Root Complex 21, a main memory 24, a graphics controller (End Point) 23, a PCI Express Link 22 making a connection between the Root Complex (chip set) 21 and the graphics controller 23, the LCD display unit 11, an embedded controller/keyboard controller IC (EC/KBC) 27, hard disk drives (HDD) 25-1 and 25-2, a BIOS-ROM 26, a flash memory 17, a keyboard 13, a touch pad 14, an AC power supply 19, a speaker 29, and the like. The HDD 25-1 and 25-2 have a disk array duplexing structure, for example, as RAID-1 (Redundant Arrays of Inexpensive Disks-1). This structure enhances data reliability by writing the same data in a plurality of drives and is also called mirroring. In the present embodiment, two HDD are employed. However, the disk array of RAID-5 or the like can also be constituted with three or more HDD.

The Root Complex 21, the graphics controller 23, and the like are devices which are in conformity with the PCI EXPRESS standards. The communications between the Root Complex 21 and the graphics controller 23 are executed over the PCI Express Link 22 arranged between the Root Complex 21 and the graphics controller 23.

The CPU 20 is a processor configured to control the operations of the computer 10, and executes various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware.

The Root Complex 21 is a bridge device configured to make a connection between a local bus of the CPU 20 and the graphics controller 23. In addition, the Root Complex 21 also has a function of executing the communications with the graphics controller 23 over the PCI Express Link 22.

The graphics controller 23 is a display controller configured to control the display unit 11 employed as a display monitor of the computer.

The EC/KBC 27 is a one-chip microcomputer on which an embedded controller for power management and a keyboard controller configured to control the keyboard 13, the touch pad 14, the battery 28, the AC power supply 19, and the like are integrated. The EC/KBC 27 has a function of controlling power-on/power-off of the computer 10, in cooperation with a power supply controller, in response to the user's operation of the power button.

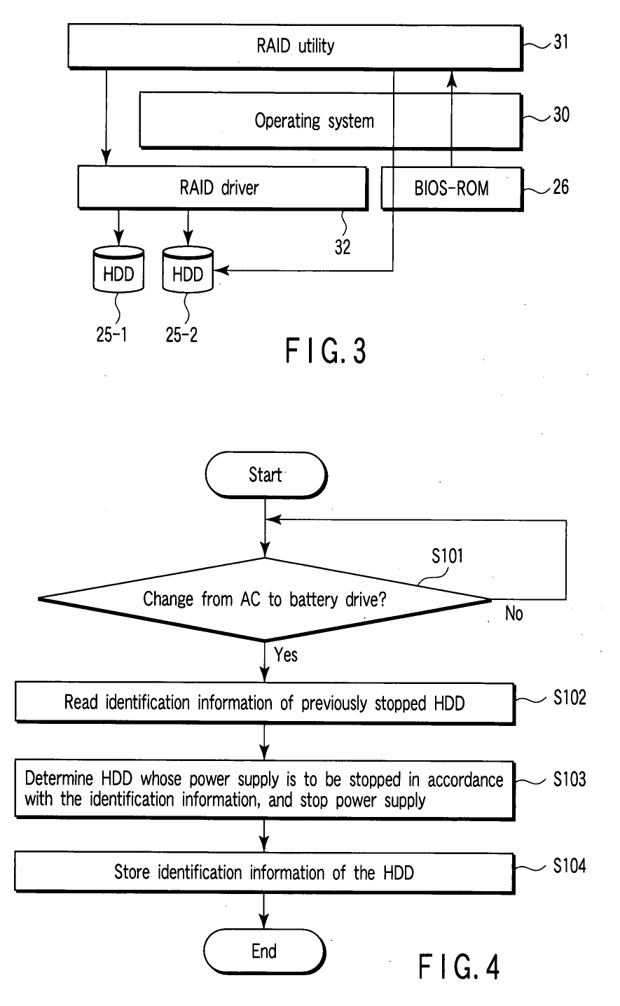

Next, FIG. 3 is a block diagram showing main functions of an external storage device and the information processing apparatus according to the embodiment of the present invention.

The information processing apparatus includes RAID utility 31, an operating system (OS) 30, a BIOS-ROM 26, a RAID driver 32, HDD 25-1, HDD 25-2, and the like.

When the AC power is changed to the battery power, the BIOS-ROM 26 sends a notice to the RAID utility 31 via the OS 30. The RAID utility 31 sends a request for temporarily suspending the duplexing to the RAID driver 32. Subsequently, the RAID driver 32 stops upgrading the data in either of HDD 25-1 and HDD 25-2, for example, HDD 25-2. The RAID utility 31 makes a request for supplying the power to the HDD 25-2 via the BIOS-ROM 26 (stopping unit: capable of stopping the supply of power to each HDD), and the supply of power to the HDD 25-2 is therefore stopped. In this case, it is stored in the flash memory 17 as power supply stop history information that the HDD for which the power supply is stopped is HDD 25-2. The power supply stop history information indicates a history of stopping the supply of power to each of HDD 25-1 and HDD 25-2. Upon the following stops of power supply to the HDD, the HDD to be stopped next time is selected so as to average the stop counts of the HDD 25-1 and HDD 25-2 with reference to the power supply stop history information (after that, the stopping unit stops the supply of power to the determined physical drive).

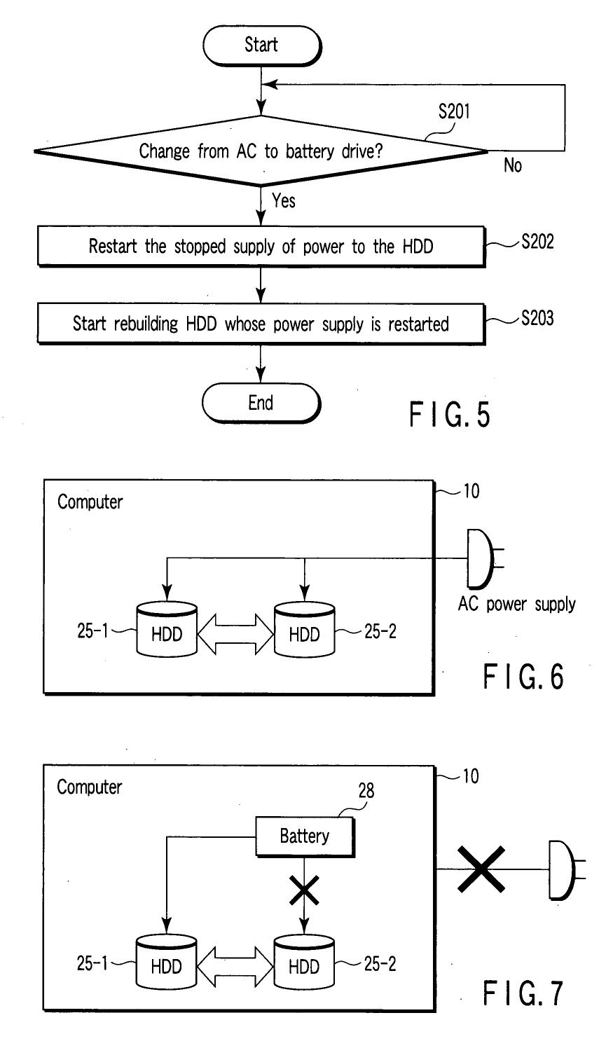

Next, a control method to which the information processing apparatus of the present invention is applied is described with reference to flowcharts of FIG. 4 and FIG. 5. In the present embodiment, the information processing apparatus is the notebook computer 10, but is not limited to this if a physical storage device such as a storage server comprises a disk array.

FIG. 4 shows a flowchart showing a case where the supply of power to one of the two HDD is stopped when the AC power supply 19 is changed to the battery 28 drive.

When the BIOS is read from the BIOS-ROM 26 by the CPU 20, the BIOS monitors whether or not the AC power supply 19 has been changed to the battery 28 drive. As shown in FIG. 6, for example, the power of AC power supply 19 is supplied to the HDD 25-1 and HDD 25-2. If it is discriminated by the BIOS that the AC power supply 19 has been changed to the battery 28 drive (YES in block S101), duplexing conducted over the HDD 25-1 and HDD 25-2 is temporarily canceled and the power supply stop history information is read as the HDD identification information stored in the flash memory 17 (block S102). On the basis of the power supply stop history information, the RAID utility 31 selects the HDD to be stopped such that the stop counts are averaged (for example, selects the HDD 25-2 to be stopped in a case where the stop count of the HDD 25-1 is two and the stop count of the HDD 25-2 is one), and stops the supply of power to the selected HDD (block S103). As shown in FIG. 7, for example, when the power supply from the AC power is changed to that from the battery 28, the supply of power to the HDD 25-2 is stopped. Subsequently, the identification information of the HDD, power supply to which is stopped, is stored in the flash memory 17 as the power supply stop history information. In other words, for example, the stop count of the HDD 25-1 is two and the stop count of the HDD 25-2 is two. Next time the HDD whose power supply is to be stopped is selected, for example, selecting the HDD 25-1 with priority or the like is preset if the stop counts of the HDD are the same. At the above selection of the HDD whose power supply is to be stopped, it is desirable to retrieve reconstructed information to be described later and select one of the HDD whose reconstruction is succeeded.

Next, FIG. 5 is a flowchart showing a case where the stopped power supply to the HDD is restarted when the power supply from the battery 28 drive has been changed to the power supply from the AC power 19.

When the BIOS is read from the BIOS-ROM 26 by the CPU, the BIOS monitors whether or not the power supply from the battery 28 drive has been changed to the power supply from the AC power 19. As shown in FIG. 7, for example, power is supplied from the battery 28 to both the HDD 25-1 and HDD 25-2. If it is discriminated by the BIOS that the power supply from the battery 28 drive has been changed to the power supply from the AC power 19 (YES in block S201), the supply of power to the HDD 25-2 whose power supply has been stopped is restarted by stop unit (block S202). Subsequently, rebuilding of the HDD 25-2 whose power supply has been stopped is started (building the duplexing state: building unit) and the power supply is returned to the duplexing state. In other words, the data in the HDD 25-2 is updated such that the data becomes the same as the data stored in the HDD 25-1 (block S203). If rebuilding is succeeded, the information (rebuilding information) that rebuilding the HDD 25-2 has been succeeded is stored in the flash memory 17.

Next, a modified example is described. In the above embodiment, the battery-operated notebook computer is explained. However, it can also be implemented as an external storage device including a plurality of HDD devices. In this case, the external storage device can receive only information that the power is supplied from the battery drive or the AC power and, on the basis of the received information, the supply of power to the HDD can also be controlled.

By employing the present embodiment, the battery duration becomes longer as the supply of power to one of the HDD is stopped during the battery operation. In addition, even if the computer falls down during the battery operation, possibility of saving the data in the HDD whose power supply is stopped can be more increased.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a battery and an AC power supply;
a plurality of physical drives included in a disk array;
a discrimination unit for discriminating whether a power supply mode is the battery or the AC power supply;
a storing unit for storing a history of stopping the power supply as power supply stop history information, for each of the physical drives;
a canceling unit for temporarily canceling a duplexing state of the disk array if it is discriminated by the discrimination unit that the power supply mode is the battery;
a determination unit for determining a physical drive whose power supply is to be stopped next time, to average power supply stop counts of the respective physical drives in accordance with the power supply stop history information stored in the storing unit; and
a stop unit for stopping the supply of power to the physical drive determined by the determination unit.

2. The apparatus according to claim 1, further comprising building unit for building the duplexing state of the physical drives,
wherein the building unit restarts the supply of power to the physical drive which is stopped by the stop unit and returns the disk array to the duplexing state if the discrimination unit discriminates that the power supply mode has been changed from the battery to the AC power supply.

3. The apparatus according to claim 1, wherein the duplexing of the disk array is based on RAID-1.

4. The apparatus according to claim 2, wherein
the building unit stores rebuilding information indicating a result of the duplexing of the physical drives in the storing unit after returning to the duplexing; and
the determination unit determines a physical drive whose power supply is to be stopped next time, of the physical drives which have been successfully rebuilt in accordance with the rebuilding information.

5. An external storage drive, comprising:
a plurality of physical drives included in a disk array;
a discrimination unit for receiving power supply mode information and discriminating whether a power supply mode is a battery or an AC power supply;
a stop unit for stopping supply of power to each of the physical drives;
a storing unit for storing a history of stopping the power supply as power supply stop history information, for each of the physical drives;
a determination unit for temporarily cancelling a duplexing state of the disk array, and determining a physical drive whose power supply is to be stopped next time, to average power supply stop counts of the respective physical drives in accordance with the power supply stop history information stored in the storing unit, if it is discriminated by the discrimination unit that the power supply mode is the battery; and
wherein the supply of power to the physical drive determined by the determination unit is stopped by the stop unit.

6. A method of controlling an information processing apparatus comprising connection unit for making connection with each of physical drives included in a disk array, the method comprising:
storing a history of stopping the power supply as power supply stop history information, for each of the physical drives, in storing unit;
discriminating whether a power supply mode is a battery or an AC power supply;
temporarily canceling a duplexing state of the disk array, and determining a physical drive whose power supply is to be stopped to average power supply stop counts of the respective physical drives in accordance with the power supply stop history information stored in the storing unit, if it is discriminated that the power supply mode is the battery; and
stopping the supply of power to each of the physical drives.

7. The method according to claim 6, further comprising building unit for building the duplexing state of the physical drives,
wherein the building unit restarts the supply of power to the physical drive which is stopped by the stop unit and returns the disk array to the duplexing state if the discrimination unit discriminates that the power supply mode has been changed from the battery to the AC power supply.

8. The method according to claim 6, wherein the duplexing of the disk array is based on RAID-1.

9. The method according to claim 6, wherein the building unit stores rebuilding information indicating a result of the duplexing of the physical drives in the storing unit after returning to the duplexing, and the determination unit determines a physical drive whose power supply is to be stopped next time, of the physical drives which have been successfully rebuilt in accordance with the rebuilding information.
